(19) United States
(12) Patent Application Publication
(10) Pub. No.: US 2026/0296678 A1
(43) Pub. Date: Oct. 1, 2026

(54) HABITATS WITH INFLATABLE HARDSHELL MODULES

(71) Applicant: Blue Origin Manufacturing, LLC, Huntsville, AL (US)

(72) Inventors: William Joseph O'Hara, IV, Berthoud, CO (US); Michael Gerry Drever, Littleton, CO (US)

(21) Appl. No.: 19/634,783

(22) Filed: Mar. 31, 2026

Related U.S. Application Data
(60) Provisional application No. 63/781,029, filed on Mar. 31, 2025.

(51) Int. Cl. B64G 1/22; B64G 1/60; B64G 99/00

(52) U.S. Cl. CPC B64G 1/2226; B64G 1/2227; B64G 1/60; B64G 99/00

(57) ABSTRACT

Habitats with inflatable hardshell modules are disclosed. In one aspect, a deployable habitat includes a main body and a habitat module coupled to the main body. The habitat module includes a plurality of nested hardshells. The deployable habitat further includes a gas source configured to provide a pressurized gas to the deployable habitat to pressurize the deployable habitat. The nested hardshells are configured to move from a stowed configuration to a deployed configuration in response to the pressurization of the deployable habitat.

### INCORPORATION BY REFERENCE TO PRIORITY APPLICATION

This application claims the benefit of U.S. Provisional Application No. 63/781,029, filed on Mar. 31, 2025, titled DEPLOYABLE HARD SHELL HABITAT MODULES, the entire content of which is incorporated by reference herein and forms a part of this specification for all purposes.

### BACKGROUND

### Field

The described technology relates generally to habitats, and in particular, to space habitats including deployable modules.

### Description of the Related Technology

Habitats can include deployable modules in different environments, including in remote locations on Earth, in orbit, on the Moon, and in other extraterrestrial environments. Deployable modules enable the habitat to be more compactly stored during transport while providing a larger habitable area after being inflated on site.

### SUMMARY CERTAIN INVENTIVE ASPECTS

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing methods of manufacturing large space habitats.

In one aspect, a deployable habitat is provided. The deployable habitat includes a main body and a habitat module coupled to the main body. The habitat module includes a plurality of nested shells. The deployable habitat also includes a gas source configured to provide a pressurized gas to an internal volume of the deployable habitat to pressurize the deployable habitat. The plurality of nested shells are configured to move from a stowed configuration to a deployed configuration in response to the pressurization of the deployable habitat, the internal volume of the deployable habitat when the plurality of nested shells are in the deployed configuration greater than the internal volume of the deployable habitat when the plurality of nested shells are in the stowed configuration.

In some embodiments, the habitat module further includes a plurality of O-rings configured to provide a seal between adjacent pairs of the plurality of nested shells in the deployed configuration.

In some embodiments, the plurality of O-rings include at least two O-rings arranged between each of the adjacent pairs of the plurality of nested shells.

In some embodiments, each of the plurality of nested shells includes a first flange and a second flange, and the at least two O-rings are arranged between the first flange of a first nested shell and the second flange of a second nested shell of the adjacent pairs of the plurality of nested shells.

In some embodiments, the first flange and the second flange of one pair of the adjacent pairs of the plurality of nested shells are angled such that an internal pressure of the deployable habitat pushes the first flange and the second flange of the adjacent pair of the plurality of nested shells towards each other.

In some embodiments, the habitat module further includes a flexible bladder configured to provide a seal that extends across each of the plurality of nested shells of the habitat module.

In some embodiments, the flexible bladder is further configured to provide the seal during the pressurization of the deployable habitat.

In some embodiments, the flexible bladder is further configured to maintain a threshold gas pressure in the internal volume of the deployable habitat after the pressurization of the deployable habitat.

In some embodiments, the flexible bladder is further configured to be folded into a pleated configuration when the habitat module is in the stowed configuration, and wherein the flexible bladder is further configured to be unfolded and pressed against internal surfaces of the plurality of nested shells in the deployed configuration.

In some embodiments, the flexible bladder is formed of a continuous material.

In some embodiments, the habitat module further includes a plurality of plates, the flexible bladder being attached to each of the plurality of nested shells via a corresponding one of the plurality of plates with the flexible bladder positioned between the plurality of nested shells and the plurality of plates.

In some embodiments, the flexible bladder is connected to first ends of each of the plurality of nested shells.

In some embodiments, the habitat module further includes a mechanical lock configured to maintain a shape of the habitat module when a gas pressure of The deployable habitat falls below a threshold gas pressure.

In some embodiments, the habitat module further comprises a guide configured to prevent the plurality of nested shells from shifting rotationally during inflation of the habitat module.

In some embodiments, a first one of the plurality of nested shells closest to the main body is connected to the main body along an outer circumference of the first nested shell.

In some embodiments, a first one of the plurality of nested shells closest to the main body is connected to the main body via a hatch, and an outer circumference of the first nested shell is spaced apart from the main body.

In another aspect, a method of deploying a deployable habitat is provided. The method includes placing the deployable habitat at a landing site, the deployable habitat including a main body and a habitat module coupled to the main body, the habitat module including a plurality of nested shells. The method also includes providing a pressurized gas to an internal volume of the deployable habitat to pressurize the deployable habitat; and deploying the habitat module from a stowed configuration to a deployed configuration in response to the pressurization of the deployable habitat. The deploying of the habitat module includes the plurality of nested shells moving from a stowed configuration to a deployed configuration in response to the pressurization of the deployable habitat. The method also includes increasing the internal volume of the deployable habitat from a first internal volume when the plurality of nested shells are in the stowed configuration to a second internal volume of the deployable habitat when the plurality of nested shells are in the deployed configuration.

In some embodiments, deploying the deployable habitat module includes engaging a plurality of O-rings arranged between adjacent pairs of the plurality of nested shells to provide a seal.

In some embodiments, the plurality of O-rings comprise at least two O-rings arranged between each of the adjacent pairs of the plurality of nested shells.

In some embodiments, each of the plurality of nested shells includes a first flange and a second flange, and the at least two O-rings are arranged between the first flange of a first nested shell and the second flange of a second nested shell of adjacent pairs of the plurality of nested shells.

In some embodiments, the first flange and the second flange of each of the plurality of nested shells are angled. The method further includes pushing the first flange and the second flange of one pair of the adjacent pairs of the plurality of nested shells towards each other using an internal pressure of the deployable habitat.

In some embodiments, the habitat module further includes a flexible bladder configured to provide a seal that extends across each of the plurality of nested shells of the habitat module.

In some embodiments, the method further includes providing the seal using the flexible bladder during the pressurization of the deployable habitat.

In some embodiments, the method further includes maintaining a threshold gas pressure in the internal volume of the deployable habitat using the flexible bladder after the pressurization of the deployable habitat.

In some embodiments, deploying the habitat module further includes unfolding the flexible bladder from a pleated configuration when the habitat module is in the stowed configuration and pressing the flexible bladder against internal surfaces of the plurality of nested shells in the deployed configuration.

In some embodiments, the method further includes engaging a mechanical lock to maintain a shape of the habitat module when a gas pressure of the deployable habitat falls below a threshold gas pressure.

In some embodiments, the method further includes preventing the plurality of nested shells from shifting rotationally during inflation of the habitat module using a guide.

In some embodiments, a first one of the plurality of nested shells closest to the main body is connected to the main body along an outer circumference of the first nested shell.

In some embodiments, a first one of the plurality of nested shells closest to the main body is connected to the main body via a hatch, and an outer circumference of the first nested shell is spaced apart from the main body.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

FIGS. 1A-1E illustrate a deployable habitat according to an embodiment of the present disclosure.

FIGS. 2A-2D illustrate another embodiment of a deployable habitat according to an embodiment of the present disclosure.

FIG. 3 is a flowchart illustrating a method of deploying a deployable habitat according to an embodiment of the present disclosure.

FIGS. 4A-4D illustrate a deployable habitat according to another embodiment of the present disclosure.

### DETAILED DESCRIPTION

When deploying habitats in remote areas, it can be desirable to design the habitat to facilitate transport of the habitat to the remote area. This can be achieved by using a modular design for the habitat and/or by storing the habitat in a compact form for transport. Certain remote areas, such as locations on Earth not accessible by ground transportation, in the Earth's orbit, on the surface of the Moon, can introduce additional challenges to transportation of the habitat. For example, when launching rockets into space, there is a premium placed on both mass and volume, such that it is impractical to launch objects that are either too massive or too large. Thus, it can be desirable to design habitats with an increased ratio of deployed volume to mass.

In addition to space applications, the deployable habitats described herein can also be used for other applications, such as a field deployable hospital or medical facility with a sanitary environment, or a clean room (for example, for semiconductor manufacturing). Having a positive pressure inside the deployable habitat (for example, a higher pressure inside the habitat than outside the habitat) can be advantageous for these applications as well as space-related applications. As described herein, deployable habitats according to the present disclosure can seal off the internal volume from the external environment, which helps provide the positive pressure and prevents external contaminants from entering the habitat, enabling the use of the habitat in vacuum or near vacuum environments in space, as a sanitary environment, or a clean room.

Aspects of this disclosure relate to an example embodiment in which a habitat can be stowed in a compact configuration for transport to a site for deployment and then deployed to provide a larger habitable area (for example, a larger livable and/or working area) after arriving at the deployment site. One conventional deployable habitat design is a soft inflatable design that can be packaged into a compact package for transport and inflated to deploy. However, soft inflatable designs are typically complicated and risky to deploy (for example. they may puncture, entangle, twist or otherwise fail during inflation). Soft inflatable habitats also lose their shape if internal pressure is lost, which can risk safety of crew of the habitat and compromise systems and supplies placed within the habitat. While traditional hardshell habitats may maintain their shape when losing internal pressure, hardshell habitats are not typically able to be compactly stored for transport or increase the usable habitable volume once deployed.

To address these issues, certain embodiments of the present disclosure include a deployable habitat that includes hardshell modules. Advantageously, these hardshell modules provide a more predictable inflation path and can at least partially maintain the shape of the habitat in the event that a gas pressure inside the deployable habitat falls below a threshold gas pressure. As described herein, the deployable habitat can include a hardshell-based, pressurizable habitat module that adds livable volume to a host module to which the habitat module is attached. The habitat module can include a plurality of nested shells with sealing interfaces to deploy into a final geometry. Mechanical locks can then be actuated to ensure that the shape of the habitat module is maintained even if internal pressure is lost, or if, for example, a gas pressure of the deployed habitat falls below a threshold gas pressure. Habitats according to embodiments of the present disclosure can also leverage a positive gas pressure for two advantageous purposes: to deploy the plurality of nested shells into a deployed configuration, and to maintain a positive pressure within the habitat relative to the external environment after the habitat is in the deployed configuration.

One additional problem addressed by embodiments of the present disclosure is the need to provide more livable volume to a module and still fit within the space available for transport of the habitat (for example, within the fairing of a rocket for space applications). Aspects of embodiments of the present disclosure can address this problem by enabling the deployable habitat to be launched in a collapsed, low profile (for example, stowed) configuration, and then be deployed once arriving at a deployment site. Once the deployment process is completed, each habitat module provides expanded habitable (for example livable or working) volume to the crew.

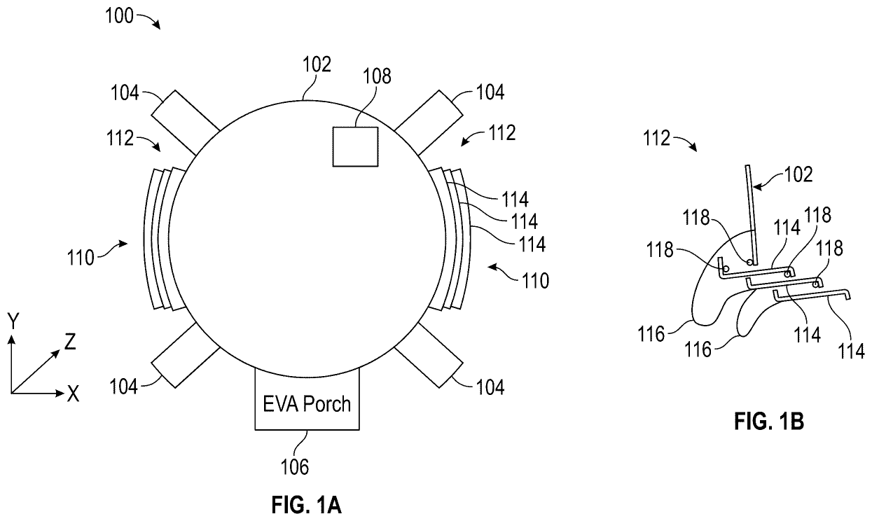

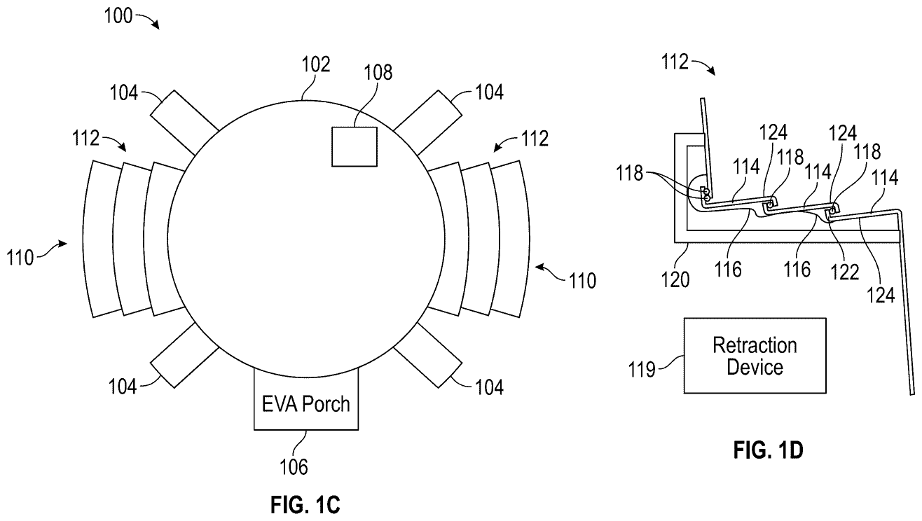

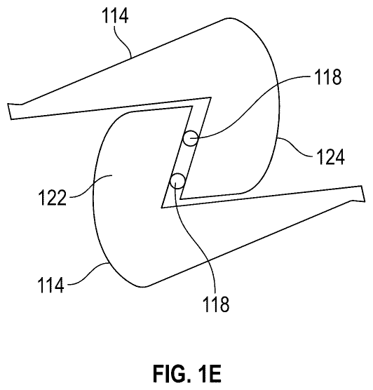

FIGS. 1A-1E illustrate a deployable habitat 100 according to an embodiment of the present disclosure. In particular, FIG. 1A is an overhead view of the habitat 100 in a stowed configuration, FIG. 1B is a cross-sectional view of a portion of a habitat module 110 in the stowed configuration, FIG. 1C is an overhead view of the habitat 100 in a deployed configuration, FIG. 1D is a cross-sectional view of the portion of the habitat module 110 in the deployed configuration, and FIG. 1E is a cross-sectional view of an interface between nested shells of the habitat module 110 in the deployed configuration.

With reference to FIGS. 1A-1E, the habitat 100 includes a main body 102, a support structure 104, a porch 106, and a pair of habitat modules 110 (also referred to as inflatable hardshell modules). In some embodiments, the habitat 100 further includes a pressurized gas source 108 configured to provide a pressurized gas to an internal volume of the habitat 100 to pressurize the habitat 100, thereby inflating the habitat modules 110. In some embodiments, the deployable habitat 100 can be an inflatable habitat. In some embodiments, the deployable habitat 100 is not utilized in its initial shape, and is configured to be deployed to attain its final (for example, usable) shape. The pressurized gas can include any mixture of gases designed to provide a habitable (for example livable or working) internal atmosphere for the crew of the habitat 100. Terrestrial and space habitats frequently replicate the environment of the surface of the Earth with a total pressure of approximately 14.7 psi composed approximately of 80% nitrogen and 20% oxygen. Some space habitats may have an internal pressure of 10.2 psi to reduce structural mass and alleviate other operational requirements. The quantity of gas required can depend on the total volume of the habitat. Those skilled in the art will understand that other pressures and internal atmospheres are also possible without departing from aspects of the present disclosure. The internal atmosphere provided in the habitat 100 can be a pressurized atmosphere. For example, a gas pressure inside the habitat 100 can be greater than a gas pressure external to the habitat 100.

The main body 102 (also referred to as a host module) may include a bulkhead providing an external structure that forms a central area of the host module. In some embodiments, the support structure 104 can include landing gear configured to support the habitat 100 on the surface of the environment. The porch 106 can provide an area for entering/exiting the habitat 100, for example, to perform extravehicular activities (EVAs) when the habitat is located on a celestial body such as the Moon or Mars.

Each of habitat modules 110 includes a plurality of nested shells 114. The plurality of nested shells 114 can comprise a plurality of nested hardshells. Each nested shell 114 can include a first flange 122 located at a first end and a second flange 124 located at a second end opposite the first end. The plurality of nested shells 114 can employ sealing interfaces 112 configured to prevent the pressurized gas from escaping, for example leaking, out of the habitat 100 and into the atmosphere external to the habitat 100. FIGS. 1A and 1B illustrate the nested shells 114 in a stowed configuration prior to pressurization of the habitat 100. As shown in FIG. 1B, the nested shells 114 overlap in the x-, y-, and z-directions to reduce the distance that the habitat module 110 extends away from the main body 102 of the habitat 100. In some examples, about 50% of a first nested shell 114 overlaps in the x-direction with a second nested shell 114 above the first nested shell 114. In some examples, about 75% of the first nested shell 114 overlaps in the x-direction with a third nested shell 114 below the first nested shell 114. Other relative amounts of overlap between adjacent nested shells 114 can be suitably implemented. In some embodiments, the nested shells 114 may be concentric.

The sealing interfaces 112 can include a first sealing interface 116 and a second sealing interface 118. The first sealing interface 116 can include a flexible bladder 116. The second sealing interface 118 can include a plurality of O-rings 118. One or more of the nested shells 114 can include an O-ring 118 at the second flange 124 at the second end. As will be described below with reference to FIG. 1E, in some embodiments, one or more of the nested shells 114 can include an O-ring 118 at the first flange 122 at the first end and an O-ring at the second flange 124 at the second end. In the stowed configuration, the plurality O-rings 118 may not seal an interface between adjacent nested shells 114. In contrast, the flexible bladder 116 can provide a seal that extends across each of the nested shells 114 for a given habitat module 110 in the stowed configuration. The flexible bladder 116 can be configured to seal an interior volume of the habitat 100 relative to an external atmosphere when the habitat 100 is in the stowed configuration. In some embodiments, the nested shell 114 closest to the main body 102 is connected to the main body 102 along an outer circumference of the nested shell 114.

The habitat module(s) 110 can be deployed (for example, inflated) by pressurizing the habitat 100. The habitat 100 can be pressurized by dispensing a pressurized gas in the interior volume of the habitat 100. As gas pressure in the interior volume increases, the nested shells 114 are configured to extend in the x-direction away from the main body 102. The nested shells 114 can be configured to extend in the x-direction until the habitat 100 reaches the deployed configuration illustrated in FIGS. 1C and 1D. Accordingly, the nested shells 114 can be configured to move from a stowed configuration to a deployed configuration in response to the pressurization of the habitat 100. The internal volume of the habitat 100 when the plurality of nested shells 114 are in the deployed configuration is greater than the internal volume of the habitat 100 when the plurality of nested shells 114 are in the stowed configuration.

The flexible bladder 116 can provide a seal for the habitat module 110 during inflation, until the O-rings 118 engage adjacent nested shells 114. Once fully inflated, the O-rings 118 and the flexible bladder 116 can provide a two-seal redundancy in the sealing of the habitat module 110. The flexible bladder 116 may also be sealed to each of the nested shells 114 individually (as shown in FIGS. 1B and 1D), such that a hole or break in the flexible bladder 116 will only permit pressurized gas in the internal volume to leak into a space between a single adjacent pair of the nested shells 114. The flexible bladder 116 can be sealed to a first end of a nested shell 114 opposite a second end. In addition, the flexible bladder 116 can prevent dirt or other contaminants present inside the habitat 100 from reaching the O-rings 118, thereby extending the lifetime of the O-rings 118.

In some embodiments, the flexible bladder 116 is formed of a continuous material that can be folded into a pleated configuration when the habitat module 110 is in the stowed configuration. As the internal pressurization inflates the habitat module 110, the pleats of the flexible bladder 116 extend and unfold in the x-direction. The pleats of the flexible bladder 116 can be configured to laydown or be pressed against the internal surfaces of the nested shells 114. In some embodiments, the flexible bladder 116 can be attached to each of the nested shells 114 using a corresponding plate, with the flexible bladder 116 positioned between the plate and the nested shell 114. The plate can be formed of or include a metal or any other suitable material. The plate may be attached to the nested shells 114 using screws, although other fasteners can also be used. The plate may be formed as a circumferential band that may be about 2 inches wide. Other shapes and sizes of the plate are also possible. In some embodiments, the flexible bladder 116 can be formed of urethane, although other flexible materials capable of providing a seal between the internal pressure of the habitat module 110 and the external environment (for example, a vacuum environment) are also possible.

In one non-limiting example shown in FIGS. 1B and 1D, the flexible bladder 116 can be connected to the first end 122 of each of the nested shells 114 except for the nested shell 114 directly adjacent to the main body 102. The nested shell 114 directly adjacent to the main body 102 may move between the stowed configuration and the deployed configuration. An end of the flexible bladder 116 closest to the main body 102 can be connected to an interior surface (or an interior of a bulkhead) of the main body 102 of the habitat 100. The flexible bladder 116 may be configured to provide a first seal between the nested shell 114 and the interior surface of the main body 102. The nested shell 114 directly adjacent to the main body 102 can be configured to form a second seal with the interior surface of the main body 102 in the deployed configuration without the use of the flexible bladder 116. The second seal can be formed when the nested shell 114 directly adjacent the main body 102 is in the fully extended position shown in FIG. 1B and one or more O-rings 118 at the first end 122 of the nested shell engage the interior surface of the main body 102.

In another non-limiting example (not illustrated), the flexible bladder 116 can be connected to the first end 122 of each of the nested shells 114. The nested shell 114 directly adjacent to the main body 102 may not move between the stowed configuration and the deployed configuration. The flexible bladder 116 can be connected to the nested shells 114 without being directly connected to the main body 102 (for example, the bulkhead) of the habitat 100. The end of the flexible bladder 116 closest to the main body 102 can be connected to an underside of the first end 122 of the nested shell 114 directly adjacent to the main body 102. The flexible bladder 116 may be configured to provide a first seal between the nested shell 114 and the interior surface of the main body 102. A second seal can be formed between the main body 102 and the nested shell 114 directly adjacent to the main body 102 without the use of the flexible bladder 116. The second seal can be formed when the main body 102 and the nested shell 114 directly adjacent to the main body 102 are directly mounted to each other, for example during manufacturing of the habitat 100 The main body 102 and the nested shell 114 directly adjacent to the main body 102 can be directly mounted using gas-tight fasteners or other gas-tight connectors (for example, one or more O-rings 118).

In some embodiments, each of the nested shells 114 may have substantially the same size and shape. For example, by the nested shells 114 having substantially the same size, the habitat module 110 may have a relatively large habitable volume compared to the size of the nested shells. However, aspects of this disclosure are not limited thereto, and in some embodiments, the nested shells 114 may have diameters that decrease in size.

In some embodiments, the habitat modules 110 can be retracted so that the size of the habitat 100 can be minimized on site and/or so that the habitat 100 can be relocated to another site for deployment. When deployed in a vacuum environment (for example, on the Moon), there may not be sufficient atmospheric pressure to compress the habitat modules 110 from the deployed configuration back into the stowed configuration. Thus, in some embodiments the habitat 100 can include a retraction device 119 configured to retract the nested shells 114 from the deployed configuration to the stowed configuration. For example, the retraction device can include a crank configured to pull the outermost nested shell 114 towards the main body 102 to return the habitat module 110 back to the stowed configuration.

In some cases, the habitat 100 may be deployed in an environment having an atmospheric pressure sufficient to collapse (for example, push) the habitat modules 110 back into the stowed configuration from the deployed configuration. Thus, in some embodiments, the habitat 100 can be configured to depressurize the habitat 100 to create a pressure differential with a higher pressure external to the habitat 100. The pressure differential may be created to be within a threshold range, such that the retraction of the habitat modules 110 does not result in sudden decreases in volume of the habitat modules 110.

FIG. 1E provides a close up cross-sectional view of an example interface between a pair of adjacent nested shells 114 according to an embodiment of the present disclosure. As shown in FIG. 1E, a plurality of O-rings 118 (two in this embodiment) can be provided between the pair of adjacent nested shells 114. This provides an additional layer of redundancy for sealing the habitat 100. In some embodiments, the seal provided by the O-rings 118 may be considered a primary seal, with the seal provided by the flexible bladder 116 as a secondary seal. Together, the two O-rings 118 and the flexible bladder 116 can provide three barriers to the external atmosphere (for example, a vacuum environment). The internal pressure within the habitat 100 pushing outwards can maintain pressure on the O-rings 118. In some embodiments, each of the O-rings can extend 360 degrees around the circumference of the corresponding nested shell 114 to provide a gas-tight seal.

O-rings 118 can be positioned between the first flange 122 of a first nested shell 114 and the second flange 124 of an adjacent nested shell 114 above the first nested shell 114. The first flange 122 and the second flange 124 may be angled such that the internal pressure of the habitat 100 pushes the nested shells 114 together into a mating engagement. In FIG. 1E, this results in the second flange 124 of the top nested shell 114 being pushed downwards with the first flange 122 of the bottom nested shell 114 being pushed upwards. The particular direction of the forces on the nested shells 114 will depend on the relative orientation of the flanges 122, 124 around the circumference of the nested shells 114. Advantageously, these forces can prevent the nested shells 114 from being released from each other during pressurization of the habitat 100.

In some embodiments, the O-rings 118 may be positioned on the second flange 124 prior to inflation, as shown in FIG. 1B. Other configurations can be suitably implemented, such as positioning the O-rings 118 on the first flange 122 prior to inflation or positioning a first O-ring on the first flange 122 and a second O-ring on the second flange 124 of the nested shells 114.

In some embodiments, the habitat module 110 can include a mechanical lock 120 configured to maintain the deployed shape of the habitat module 110 in the event of loss of internal pressure. The mechanical lock 120 can be embodied by any physical element that prevents the habitat module 110 from collapsing during a loss of pressure. For example, the mechanical lock 120 can include a latching strut connected between the main body 102 and the nesting shell 114 furthest from the main body 102. Depending on the implementation, the mechanical lock 120 may be located inside and/or outside of the habitat module 110. When located on the exterior of the habitat 100, the mechanical lock 120 will not occupy the livable volume of the habitat 100. In some embodiments, the mechanical lock 120 has a zig-zag shape that substantially conforms to the shape of the deployed nested shells 114 to provide a slim form factor that structurally connects the main body 102 to the nested shell 114 furthest from the main body 102. The mechanical lock 120 can also be configured to provide an additional source of pressure on the O-rings during deployment of the habitat module 110 and/or during a loss of internal pressure.

In some embodiments, the habitat module 110 can further include one or more guides configured to prevent the nested shells 114 from shifting rotationally during inflation of the habitat module 110. In some embodiments, the mechanical lock 120 can also perform the function of the guides. In certain embodiments, however, the flexible bladder 116 has sufficient stiffness to prevent a relative rotational shift of the nested shells 114 during inflation.

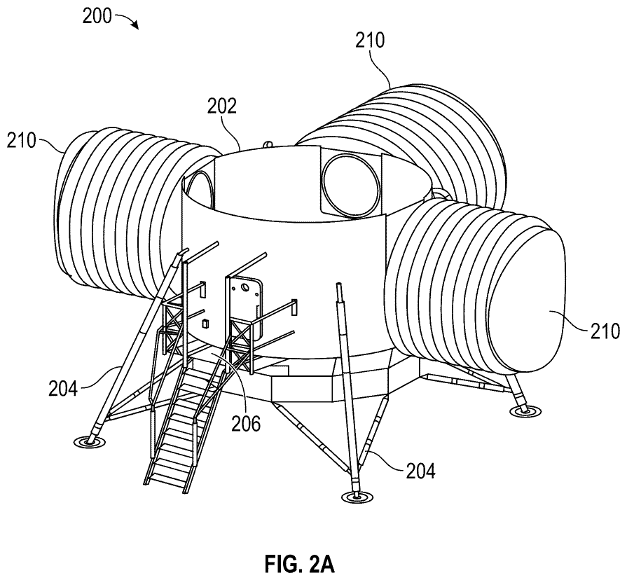

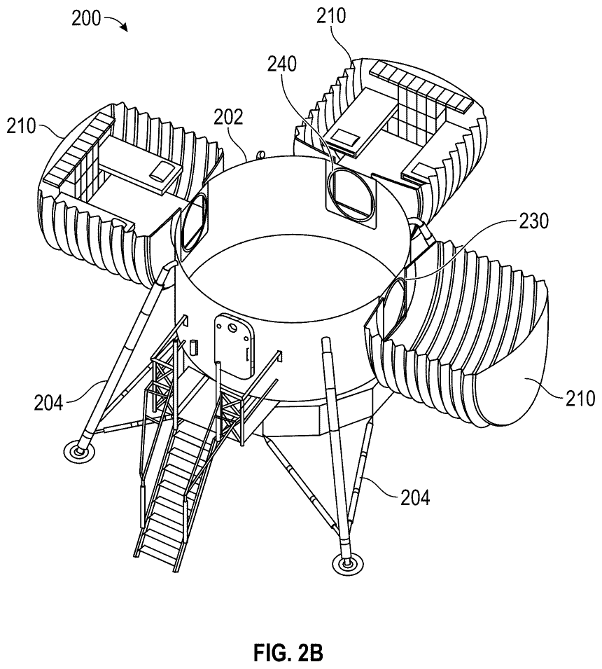

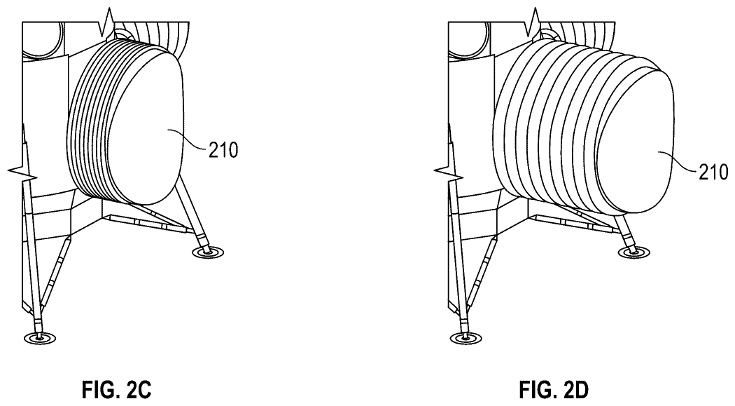

FIGS. 2A-2D illustrate another embodiment of a deployable habitat 200. In particular, FIG. 2A is a perspective view of the habitat 200, FIG. 2B is a cross-sectional view of the habitat 200, FIG. 2C is a view of a habitat module 210 in a stowed configuration, and FIG. 2D is a view of the habitat module 210 in a deployed configuration. As shown in FIGS. 2A and 2B, the habitat 200 includes a main body 202, a support structure 204, a porch 206, and three habitat modules 210. In some embodiments, the deployable habitat 200 can be an inflatable habitat. In some embodiments, the deployable habitat 200 is not utilized in its initial shape, and is configured to be deployed to attain its final (for example, usable) shape.

Embodiments of the habitat 200 may include any of the features of the habitat 100 illustrated in FIGS. 1A-1E and should not be limited to the particular embodiments described. For example, features of one embodiment may be combined with features of another embodiment. The habitat shown in FIGS. 2A-2D will now be discussed in detail and features not discussed will be understood to be similar, or identical, to those discussed elsewhere herein. Some or all of the features discussed with respect to FIGS. 2A-2D may be incorporated into the other embodiments described herein.

With reference to FIGS. 2A-2D, each of the habitat modules 210 can be connected to the main body 202 via a hatch 240 in the main body 202 that enables people to move between the main body 202 and the habitat module 210. In the habitat module 210, the nested shell closest to the main body can include a surface or bulkhead having an opening 230. The opening 230 of the habitat module 210 can align with a corresponding hatch 240 of the main body. In the habitat module 210, the nested shell closest to the main body 202 can be connected to the main body 202 at a location just surrounding the hatch 240, while the outer circumference of the habitat module 210 is spaced apart from (for example, not in contact with) the main body 202. In some embodiments, the habitat 200 of FIGS. 2A-2D can include an additional bulkhead integrated into nested shell located closest to the main body 202 in order to increase the final volume of the habitat module 210 compared to the habitat 100 of FIGS. 1A-1E. The embodiments of FIGS. 1A-1E without the additional bulkhead can be more compact as the nested shells can nest practically within the main body 102, whereas in the embodiments of FIGS. 2A-2D that include the additional bulkhead, the habitat module 210 can sit outside the main body 202 with the benefit of providing increased volume.

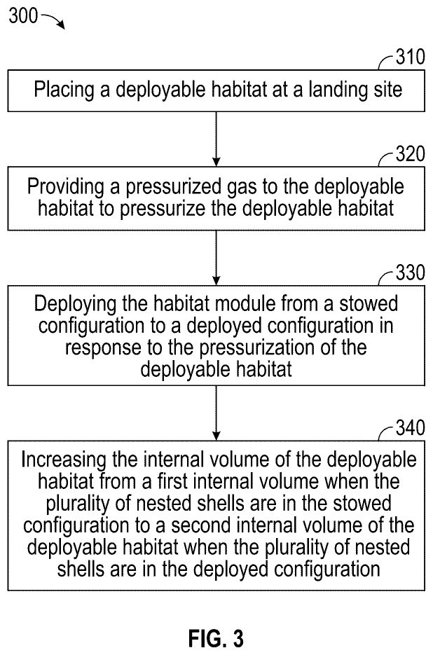

FIG. 3 is a flowchart illustrating a method 300 of deploying a deployable habitat according to an embodiment of the present disclosure. The method 300 can be used to deploy the habitats 100, 200 of FIGS. 1A-2D, or any other habitat according to embodiments of the present disclosure.

At block 310, the method 300 involves placing the deployable habitat at a site, for example a landing site. The deployable habitat 100, 200 includes a main body 102, 202, and a habitat module 110, 210 coupled to the main body 102, 202. The habitat module 110, 210 includes a plurality of nested shells 114.

At block 320, the method 300 involves providing a pressurized gas to an internal volume of the deployable habitat to pressurize the deployable habitat. The pressurized gas can be provided from a pressurized gas source.

At block 330, the method 300 involves deploying the habitat module 110, 210 from a stowed configuration to a deployed configuration in response to the pressurization of the deployable habitat. The deploying of the habitat module 110, 210 includes the nested shells 114 moving from a stowed configuration to a deployed configuration in response to the pressurization of the deployable habitat 100, 200.

At block 340, the method 300 involves increasing the internal volume of the deployable habitat from a first internal volume when the plurality of nested shells are in the stowed configuration to a second internal volume of the deployable habitat when the plurality of nested shells are in the deployed configuration.

In some embodiments, the pressurized gas is provided at a substantially steady rate below a threshold flow rate so that the inflation of the habitat modules 110, 210 does not result in any twisting or uneven movement of the nested shells 114. As the nested shells 114 deploy the internal volume of the habitat module 110, 210 increases, which can reduce the internal pressure, leading to stalling or slowing of the deployment. By providing the pressurized gas at the steady rate below the threshold flow rate, sudden increases in volume (and thus reductions in pressure) can be avoided, preventing stalling or slowing of the deployment. As described herein, in some embodiments guides may be included to help guide the inflation of the nested shells 114 to help prevent the nested shells 114 from shifting rotationally. However, in some embodiments the flexible bladder 116 provides sufficient stability to prevent rotational shifting of the nested shells 114.

The pressurized gas source can continue providing the pressurized gas until the first flange 122 and the second flange 124 of each pair of adjacent nested shells engage the O-rings 118 arranged therebetween to form a seal. Once all of the seals formed by the O-rings 118 have engaged, the habitat module 110, 210 may be in its final shape such that full pressurization of the habitat 100, 200 can occur. The pressurized gas source can continue to provide the pressurized gas after the final shape of the habitat module 110, 210 is achieved until the habitat 100, 200 reaches full pressurization (for example, a minimal threshold pressure has been reached).

In some embodiments, the habitat modules 110, 210 can be retracted so that the size of the habitat 100, 200 can be minimized at the landing site and/or so that the habitat 100, 200 can be relocated to another site for deployment. When deployed in a vacuum environment (for example, on the Moon), there not be sufficient atmospheric pressure to compress the habitat modules 110, 210 from the deployed configuration back into the stowed configuration. Thus, in some embodiments the habitat 100, 200 can include a retraction device 119 configured to retract the nested shells 114 from the deployed configuration to the stowed configuration. For example, the retraction device can include a crank configured to pull the outermost nested shell 114 towards the main body 102 to return the habitat module 110, 210 back to the stowed configuration.

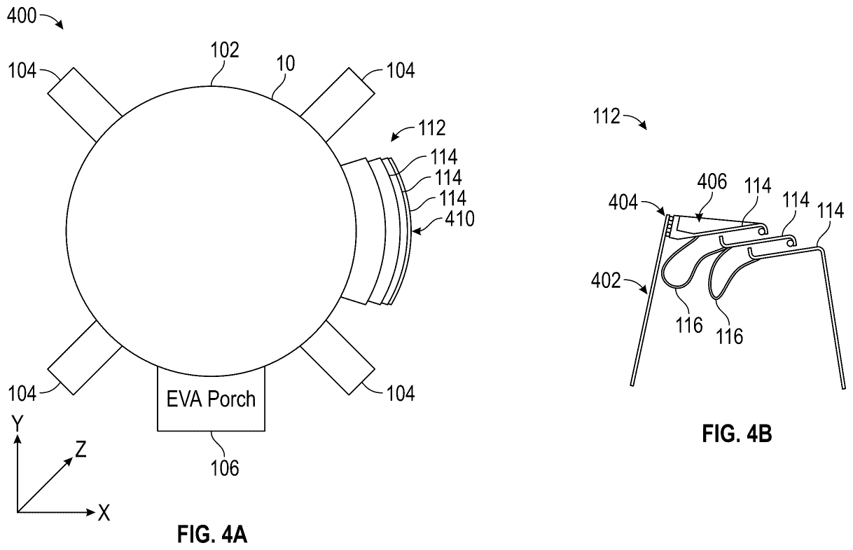

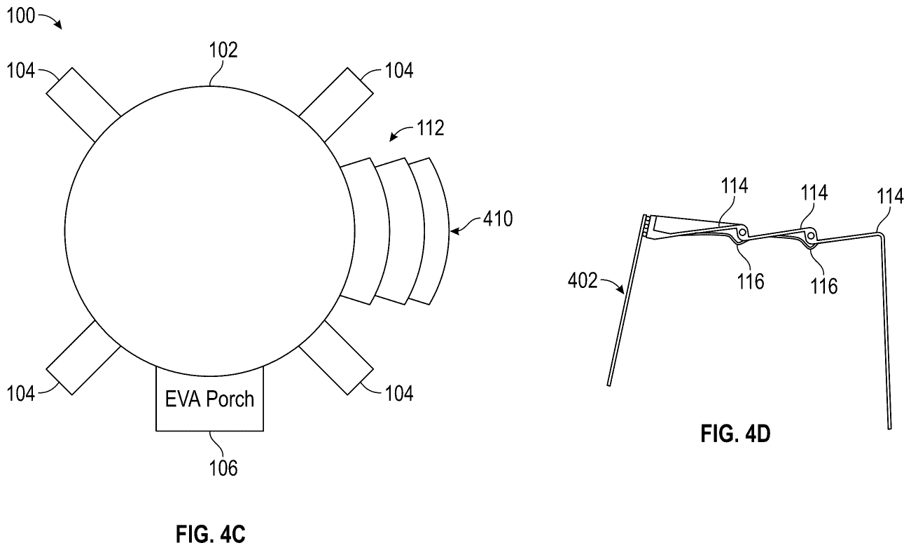

FIGS. 4A-4D illustrate a deployable habitat 400 according to another embodiment of the present disclosure. In particular, FIG. 4A is an overhead view of the habitat 400 in a stowed configuration, FIG. 4B is a cross-sectional view of a portion of a habitat module 410 in the stowed configuration, FIG. 4C is an overhead view of the habitat 400 in a deployed configuration, FIG. 4D is a cross-sectional view of the portion of the habitat module 410 in the deployed configuration

Embodiments of the habitat 400 may include any of the features of the habitat 100 illustrated in FIGS. 1A-1E and should not be limited to the particular embodiments described. For example, features of one embodiment may be combined with features of another embodiment. The habitat shown in FIGS. 4A-4D will now be discussed in detail and features not discussed will be understood to be similar, or identical, to those discussed elsewhere herein. Some or all of the features discussed with respect to FIGS. 4A-4D may be incorporated into the other embodiments described herein.

With reference to FIGS. 4A-4D, the nested shell 114 closest to the main body 102 can be attached to an end cone bulkhead 402 via a bolted interface 404. The bolted interface 404 can include a plurality of circumferential O-rings (for example, three O-rings) to seal the nested shell 114 closest to the main body 102 to the end cone bulkhead 402. The nested shell 114 closest to the main body 102 can include a gusset 406 shaped to be attached to the end cone bulkhead 402.

The deployable habitats described herein can provide at least some of the benefits of inflatable habitats together with the at least some of the benefits of traditional hardshell habitats. For example, the disclosed deployable habitats can use a fraction of the volume of a traditional hardshell module while also providing the same pressurized volume after deployment. In addition, the described inflatable habitats can retain their shape during a depressurization event, similar to a traditional hardshell.

Aspects of this disclosure may also be more reliable than comparable inflatable habitats while providing more volume per unit weight than traditional hard shell habitats. In some embodiments, the described habitat modules can be incorporated into a crewed or uncrewed lander to convert the lander into a permanent habitat. This can improve the investment into the lander vehicle with significant cost savings and manufacturing efficiencies.

### Terminology

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A deployable habitat comprising:
a main body;
a habitat module coupled to the main body, the habitat module comprising a plurality of nested hardshells; and
a gas source configured to provide a pressurized gas to an internal volume of the deployable habitat to pressurize the deployable habitat, the plurality of nested hardshells configured to move from a stowed configuration to a deployed configuration in response to the pressurization of the deployable habitat, the internal volume of the deployable habitat when the plurality of nested hardshells are in the deployed configuration greater than the internal volume of the deployable habitat when the plurality of nested hardshells are in the stowed configuration.

2. The deployable habitat of claim 1, wherein the habitat module further comprises a plurality of O-rings configured to provide a seal between adjacent pairs of the plurality of nested hardshells in the deployed configuration.

3. The deployable habitat of claim 2, wherein the plurality of O-rings comprise at least two O-rings arranged between each of the adjacent pairs of the plurality of nested hardshells.

4. The deployable habitat of claim 3, wherein each of the plurality of nested hardshells comprises a first flange and a second flange, and the at least two O-rings are arranged between the first flange of a first nested hardshell and the second flange of a second nested hardshell of the adjacent pairs of the plurality of nested hardshells.

5. The deployable habitat of claim 4, wherein the first flange and the second flange of one pair of the adjacent pairs of the plurality of nested hardshells are angled such that an internal pressure of the deployable habitat pushes the first flange and the second flange of the adjacent pair of the plurality of nested hardshells towards each other.

6. The deployable habitat of claim 1, wherein the habitat module further comprises a flexible bladder configured to provide a seal that extends across each of the plurality of nested hardshells of the habitat module.

7. The deployable habitat of claim 6, wherein the flexible bladder is further configured to provide the seal during the pressurization of the deployable habitat.

8. The deployable habitat of claim 6, wherein the flexible bladder is further configured to maintain a threshold gas pressure in the internal volume of the deployable habitat after the pressurization of the deployable habitat.

9. The deployable habitat of claim 6, wherein the flexible bladder is further configured to be folded into a pleated configuration when the habitat module is in the stowed configuration, and wherein the flexible bladder is further configured to be unfolded and pressed against internal surfaces of the plurality of nested hardshells in the deployed configuration.

10. The deployable habitat of claim 6, wherein the flexible bladder is formed of a continuous material.

11. The deployable habitat of claim 6, wherein the habitat module further comprises a plurality of metal plates, the flexible bladder being attached to each of the plurality of nested hardshells via a corresponding one of the plurality of metal plates with the flexible bladder positioned between the plurality of nested hardshells and the plurality of metal plates.

12. The deployable habitat of claim 6, wherein the flexible bladder is connected to first ends of each of the plurality of nested hardshells.

13. The deployable habitat of claim 1, wherein the habitat module further comprises a mechanical lock configured to maintain a shape of the habitat module when a gas pressure of the deployable habitat falls below a threshold gas pressure.

14. The deployable habitat of claim 1, wherein the habitat module further comprises a guide configured to prevent the plurality of nested hardshells from shifting rotationally during inflation of the habitat module.

15. The deployable habitat of claim 1, wherein a first one of the plurality of nested hardshells closest to the main body is connected to the main body along an outer circumference of the first nested hardshell.

16. The deployable habitat of claim 1, wherein a first one of the plurality of nested hardshells closest to the main body is connected to the main body via a hatch, and an outer circumference of the first nested hardshell is spaced apart from the main body.

17. A method of deploying a deployable habitat, the method comprising:
placing the deployable habitat at a landing site, the deployable habitat including a main body and a habitat module coupled to the main body, the habitat module comprising a plurality of nested hardshells;
providing a pressurized gas to an internal volume of the deployable habitat to pressurize the deployable habitat;
deploying the habitat module from a stowed configuration to a deployed configuration in response to the pressurization of the deployable habitat, the deploying of the habitat module comprising the plurality of nested hardshells moving from a stowed configuration to a deployed configuration in response to the pressurization of the deployable habitat; and
increasing the internal volume of the deployable habitat from a first internal volume when the plurality of nested hardshells are in the stowed configuration to a second internal volume of the deployable habitat when the plurality of nested hardshells are in the deployed configuration.

18. The method of claim 17, wherein deploying the deployable habitat module comprises engaging a plurality of O-rings arranged between adjacent pairs of the plurality of nested hardshells to provide a seal.

19. The method of claim 18, wherein the plurality of O-rings comprise at least two O-rings arranged between each of the adjacent pairs of the plurality of nested hardshells.

20. The method of claim 19, wherein each of the plurality of nested hardshells comprises a first flange and a second flange, and the at least two O-rings are arranged between the first flange of a first nested hardshell and the second flange of a second nested hardshell of adjacent pairs of the plurality of nested hardshells.

21. The method of claim 20, wherein the first flange and the second flange of each of the plurality of nested hardshells are angled, and wherein the method further comprises pushing the first flange and the second flange of one pair of the adjacent pairs of the plurality of nested hardshells towards each other using an internal pressure of the deployable habitat.

22. The method of claim 17, wherein the habitat module further comprises a flexible bladder configured to provide a seal that extends across each of the plurality of nested hardshells of the habitat module.

23. The method of claim 22, further comprising providing the seal using the flexible bladder during the pressurization of the deployable habitat.

24. The method of claim 22, further comprising maintaining a threshold gas pressure in the internal volume of the deployable habitat using the flexible bladder after the pressurization of the deployable habitat.

25. The method of claim 22, wherein deploying the habitat module further comprises unfolding the flexible bladder from a pleated configuration when the habitat module is in the stowed configuration and pressing the flexible bladder against internal surfaces of the plurality of nested hardshells in the deployed configuration.

26. The method of claim 17, further comprising engaging a mechanical lock to maintain a shape of the habitat module when a gas pressure of the deployable habitat falls below a threshold gas pressure.

27. The method of claim 17, further comprising preventing the plurality of nested hardshells from shifting rotationally during inflation of the habitat module using a guide.

28. The method of claim 17, wherein a first one of the plurality of nested hardshells closest to the main body is connected to the main body along an outer circumference of the first nested hardshell.

29. The method of claim 17, wherein a first one of the plurality of nested hardshells closest to the main body is connected to the main body via a hatch, and an outer circumference of the first nested hardshell is spaced apart from the main body.
